(19) United States
(12) Patent Application Publication
(10) Pub. No.: US 2020/0200132 A1
(43) Pub. Date: Jun. 25, 2020

(54) A DISTRIBUTOR FUEL RAIL AND A METHOD FOR MANUFACTURING A DISTRIBUTOR FUEL RAIL

(71) Applicant: SANDVIK MATERIALS TECHNOLOGY DEUTSCHLAND GMBH, Düsseldorf (DE)

(72) Inventors: Thomas FROBÖSE, Versmold (DE); Carl-Filip LINDAHL, Sandviken (SE); Christofer HEDVALL, Bielefeld (DE)

(73) Assignee: SANDVIK MATERIALS TECHNOLOGY DEUTSCHLAND GMBH, Düsseldorf (DE)

(21) Appl. No.: 16/638,851

(22) PCT Filed: Sep. 12, 2018
(86) PCT No.: PCT/EP2018/074548

§ 371 Date: Feb. 13, 2020

(30) Foreign Application Priority Data
Sep. 14, 2017 (DE) 10 2017 121 362.7

(51) Int. Cl. F02M 55/02; F02M 61/14

(52) U.S. Cl. CPC F02M 55/025; F02M 69/465; F02M 61/14

(57) ABSTRACT

The present disclosure relates to a diesel distributor fuel rail for a diesel combustion engine with a diesel distributor conduit and a plurality of injector cups in fluid connection with a diesel distributor conduit. In order to make combustion engines having a smaller cylinder capacity more efficient, it is necessary to enhance fuel pressure in the distributor fuel rail. On the other hand the footprint available for the distributor fuel rail has not changed. According to the present disclosure it is thus suggested to provide at least a section of the distributor conduit by a tube made of an austenitic stainless steel comprising, in weight %, C≤0.080, 8.00≤Mn≤10.00 Si≤1.00, P≤0.030 S≤0.030 19.00≤Cr≤21.50, 5.50≤Ni≤7.50, 0.15≤N≤0.40, Mo≤0.75, Cu≤0.75, balance Fe and normally occurring impurities.

### TECHNICAL FIELD

The present disclosure relates to a distributor fuel rail for a combustion engine with a tubing, wherein the tubing comprises a seamless tube of a certain composition.

The present disclosure also relates to the use of a seamless tube of a certain composition in a distributor fuel rail for injection of fuel into a combustion engine. The distributor fuel rails are inter alia used in connection to the design of Gasoline Direct Injection (GDI) systems as well as Diesel Direct Injection systems for the automotive industry.

The present disclosure further relates to a method for manufacturing a distributor fuel rail.

### BACKGROUND

Fuel is typically injected into a combustion engine. The injection may either be effected into the actual combustion chamber or into a pre-chamber or into an intake pipe. In order to do so, a distributor fuel rail is mounted to the combustion engine, wherein the distributor fuel rail is effectively coupled to a fuel pump. The fuel pump generates a pressure in the fuel guided by the distributor fuel rail, wherein the operating pressure is typically above 300 bar. Austenitic steels may be used for the distributor fuel rail in order to provide the required pressure resistance, heat resistance and corrosion resistance. Austenitic steels also fulfill the requirements on a tube to be used as a GDI-rail or a Diesel Direct Injection rail.

In order to make combustion engines having a smaller cylinder capacity more efficient, it is necessary to enhance fuel pressure in the distributor fuel rail. On the other hand, the footprint available for the distributor fuel rail has not changed.

Consequently, tubings have to be provided, which can withstand higher fuel pressure and simultaneously have an increased corrosion resistance against additives in the fuel. One solution could be to increase a wall thickness of the tubings. However, this makes the manufacturing of the tubing of the distributor fuel rail more complicated.

It is thus an aspect of the present disclosure to provide a distributor fuel rail for a combustion engine with the distributor conduit and a plurality of injector cups in fluid connection with the distributor conduit, which are failure safe at the required increased fuel pressures and simultaneously can be manufactured cost effectively. Furthermore it is an aspect of the present disclosure to provide a distributor fuel rail at reduced weight.

### SUMMARY

At least one of the above-mentioned aspects is addressed by a distributor fuel rail for a combustion engine according to claim 1.

Fuel in to the sense of the present disclosure denotes every liquid fuel that can release energy, e.g. diesel and gasoline/petrol.

In an embodiment, the tubing of the distributor fuel rail comprises a distributor conduit, a plurality of injector cups in fluid communication with the distributor conduit and at least one feeder line in fluid communication with the distributor conduit. In an embodiment either of these elements could have a section made of a seamless tube according to the present disclosure.

According the present disclosure at least a section of the distributor conduit is provided by a seamless tube made of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

In another embodiment, the seamless tube is made of an austenitic stainless steel consisting of or comprising the same above-mentioned elements but with a maximum content in weight % of C≤0.040.

This austenitic stainless steel is known as a 21-6-9 stainless steel (also denoted UNS S21900) with a high level of Mn, a low level of Ni and the addition of N. It is characterized by high mechanical strength in the hard condition, very good impact toughness even at high temperatures in the peripherals of a combustion engine and very good high temperature oxidation resistance.

Tubes, made of an austenitic 21-6-9 stainless steel so far have only been provided as welded tubes. A welded tube is manufactured for example by bending a flat steel sheet into a tube, and welding the joint together to form a seam.

A potential disadvantage of such welded tubes is the risk of cracking, wherein the weld zone is the preferential location for cracking. This circumstance was shown in fatigue experiments with welded tubes of 21-6-9 steel. Especially, this is a problem at places where tubes are subject to extreme conditions. With extreme conditions are meant for example high mechanical stresses, high temperatures, high temperature gradients as well as high pressures or high pressure gradients. The risk of cracking is a problem in particular in applications in distributor fuel rails.

The tube used for at least a part or a section of the distributor fuel rail according to the present disclosure is made of an austenitic 21-6-9 stainless steel as described above, but is a seamless tube.

The advantages of a seamless tube are an increase in the lifetime of components, the possibility to design for lower weight at equal strength as well as a better quality of the inner shape of the seamless tube when compared to a welded tube.

Another advantage of a seamless tube over a welded tube is the possibility to withstand higher hoop stresses. Thus, within a pulse pressure testing, a stress-cycle (S-N) curve also known as Wöhler curve was carried out. The results showed that for welded and seamless tubes with the same outer diameter and same wall thickness, the seamless tubes will always withstand higher hoop stresses independent of the applied pressures. Consequently, it is possible to manufacture a seamless tube that has, when compared to a welded tube, a lower wall thickness but can withstand equal hoop stresses. For this reason, it is possible to save material as well as weight which is a fundamental advantage especially in applications for the automotive industry.

In an embodiment, the seamless tube used for the distributor conduit is made of an austenitic stainless steel consisting of, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

It should be pointed out that for those above-mentioned elements, the austenitic stainless steel comprises or consists of, where no lower limit of the content is given, the minimum in weight % can be “0”. Those elements are C, P, S, Mo and Cu.

The austenitic stainless alloy as defined hereinabove or hereinafter may optionally comprise one or more of the following elements selected from the group of Al, V, Nb, Ti, O, Zr, Hf, Ta, Mg, Pb, Co, Bi, Ca, La, Ce, Y and B. These elements may be added during the manufacturing process in order to enhance e.g. deoxidation, corrosion resistance, hot ductility and/or machinability. However, as known in the art, the addition of these elements has to be limited depending on which element is present. Thus, if added the total content of these elements is less than or equal to 1.0 weight %.

The term “impurities” as referred to herein is intended to mean substances that will contaminate the austenitic stainless alloy when it is industrially produced, due to the raw materials such as ores and scraps, and due to various other factors in the production process, and are allowed to contaminate within the ranges not adversely affecting the austenitic stainless alloy as defined hereinabove or hereinafter.

In an embodiment according to the present disclosure, the tube is obtained by a method comprising the steps: providing a melt of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities, extruding a billet from the melt, hot forming the billet into a tubular hollow, cooling the hollow, and cold forming the hollow into the tube.

In an embodiment the hot forming is effected by hot rolling.

In an embodiment, a melt of an austenitic stainless steel is provided, wherein the austenitic stainless steel consists of, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo0.75, Cu≤0.75, balance Fe and normally occurring impurities.

In another embodiment, the austenitic stainless steel consists of or comprises the same above-mentioned elements but with a maximum content in weight % of C≤0.040.

In an embodiment of the present disclosure, the cold forming is effected by cold pilger milling or cold drawing.

In an embodiment of the present disclosure, the tube is, after a process comprising the steps of extruding, hot forming and cold forming, such as cold pilger milling, of the hollow, cold drawn through a drawing die.

In a further embodiment of the present disclosure, the tube is after cold forming, such as after cold pilger milling or after cold pilger milling and cold drawing, treated by ring autofrettage or ball autofrettage.

Autofrettage of the finished tube will provide for an enhanced yield strength and reduced crack growth.

In another embodiment, the tube is after cold forming annealed at a temperature in a range from 400° C. to 460° C., wherein during annealing, the tube is kept in a controlled atmosphere.

Annealing of the tube after cold forming enables a high tensile strength and high elongation in high-pressure applications simultaneously. Consequently, a tube undergoing an annealing step after cold pilger milling or after cold pilger milling and cold drawing is suitable as a tube for a distributor fuel rail.

In an embodiment of the present disclosure, the tube has a wall thickness which is equal to or larger than one quarter of the outer diameter of the tube or the tube has a wall thickness which is equal to or larger than one quarter of the outer diameter of the tube.

In another embodiment of the present disclosure, the tube has an outer diameter of 30 mm or less and a wall thickness of 10 mm or less. Still it is an option that wall thickness is equal to or larger than one third of the outer diameter of the tube.

In yet another embodiment of the present disclosure, the tube has an outer diameter of 10 mm and a wall thickness of 2.5 mm.

In an embodiment of the present disclosure, the tube has an outer diameter of 6.35 mm and a wall thickness of 2.15 mm.

In yet another embodiment of the present disclosure, the tube has an outer diameter of 14.3 mm and a wall thickness of 3.7 mm.

In automotive applications, the footprint for the tubing of a distributor rail is restricted and it is essential to save weight. Thus, for automotive applications it is necessary to manufacture the tubing at least in parts with thin walls.

An embodiment of the present disclosure relates to a combustion engine comprising a distributor fuel rail according to an embodiment thereof as it has been described above.

Yet another embodiment of the present disclosure relates to a use of a distributor fuel rail according to an embodiment thereof as it has been described above in a combustion engine. Further, the disclosure relates to use of distributor fuel rail according to an embodiment thereof as it has been described above in a combustion engine of a vehicle.

The combustion engine in an embodiment may alternatively be a diesel engine or an Otto engine (petrol/gasoline engine). It is apparent that the term fuel used in the present disclosure may alternatively refer to Diesel fuel or normal petrol/gasoline or any other liquid fuel.

The distributor fuel rail according to an embodiment of the present disclosure can be used for guiding fuel pressurized at 800 bar or more or at 1000 bar or more.

In an embodiment, the fuel distributor rail, in particular the diesel fuel distributor rail, is used for guiding fuel pressurized at 1800 bar or more.

Insofar as in the foregoing as well as in the following detailed description of embodiments and claims reference is made to the distributor fuel rail or to the method for manufacturing the distributor fuel rail, the features described are applicable for both the distributor fuel rail and the method for manufacturing the distributor fuel rail.

At least one of the above aspects is also solved by a method for manufacturing a distributor fuel rail, wherein manufacturing of a tube forming at least part of the distributor fuel rail comprises the steps: providing a melt of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities, extruding a billet from the melt, hot forming the billet into a tubular hollow, cooling the hollow, and cold forming the hollow into the tube.

By the steps of this method according to the present disclosure a seamless tube is provided.

In an embodiment, a melt of an austenitic stainless steel is provided, wherein the austenitic stainless steel consists of, in weight %, C≤0.080, 8.00≤Mn10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

In another embodiment of the present disclosure, a melt of an austenitic stainless steel is provided, wherein the austenitic stainless steel consists of or comprises the same above-mentioned elements but with a maximum content in weight % of C≤0.040.

In an embodiment of the present disclosure, the step of cold forming is cold pilger milling or cold drawing.

Cold forming processes are used for forming a hollow of metal into a tube. The cold forming of the final seamless tube not only changes its properties due to strain hardening going along with the cold forming, but the tube's wall thickness is reduced as is its inner and outer diameter. By cold forming a hollow into a tube, for example by cold pilger milling or cold drawing, a tube with exact dimensions can be manufactured.

Pilger milling is a widely-used method to reduce the dimensions of a tube. Pilger milling as it is considered here, is performed at room temperature and thus is known as cold pilger milling. During pilger milling (in the present method), the hollow is pushed over a calibrated mandrel defining the inner diameter of the finished tube. The hollow is engaged by two calibrated rollers defining the outer diameter of the tube. The rollers roll the hollow in a longitudinal direction over the mandrel.

At the beginning of the pilger milling process, the hollow is moved by a driver into the chuck of the feeder. At a front point of return of the roll stand in the feed direction of the hollow, the rollers have an angular position in which the hollow can be inserted into the infeed pockets of the rollers and can be located between the rollers. The two rollers being vertically mounted above each other at the roll stand, roll over the hollow by rolling back and forth in a direction parallel to the feed direction of the hollow. During the motion of the roll stand between the front point of return and the rear point of return, the rollers stretch out the hollow over the mandrel mounted inside the hollow.

The rollers and the mandrel are calibrated such that the gap formed between the rollers and the mandrel in the section of the rollers denoted as the working caliber is continuously reduced from the wall thickness of the hollow prior to the forming to the wall thickness of the completely rolled tube. Furthermore, the outer diameter defined by the rollers is reduced from the outer diameter of the hollow to the outer diameter of the finished tube. In addition, the inner diameter defined by the mandrel is reduced from the inner diameter of the hollow to the inner diameter of the finished tube. Further to the working caliber, the rollers comprise a planing caliber. The planing caliber neither reduces the wall thickness of the tube nor the inner or the outer diameter of the tube, but is used for planing the surfaces of the tube to be manufactured. When the rollers have reached the rear point of return of the roll stand, the rollers are at an angular position, wherein the rollers form an escape pocket to bring the rollers out of engagement with the tube.

A feeding of the hollow in the feed direction occurs either at the front point of return of the roll stand or at the front point of return as well as at the rear point of return of the roll stand. In an embodiment, each section of the hollow can be rolled multiple times. In this embodiment, the steps of feeding the hollow in the feed direction are significantly smaller than the path of the roll stand from the front point of return to the rear point of return. By rolling each section of the tube multiple times, a uniform wall thickness and roundness of tube, a high surface quality of the tube as well as uniform inner and outer diameters can be achieved.

In order to obtain a uniform shape of the finalized tube, the hollow in addition to a stepwise feeding experiences an intermittent rotation about its axis of symmetry. Rotation of the hollow in an embodiment is provided at at least one point of return of the roll stand, i.e. once the hollow is out of engagement with the rollers at the infeed pockets and release pockets, respectively.

In an embodiment of the present disclosure, cold forming of the hollow into the tube is carried out by cold drawing or the tube after cold pilger milling cold drawn.

Drawing, as it is considered here, is performed at room temperature and thus is known as cold drawing.

Different drawing processes of drawings can be applied as embodiments of the present disclosure, i.e. tube drawing, core drawing and rod drawing. During the process of tube drawing, only the outer diameter of the tube is reduced by drawing the tube through a drawing die without further defining the inner diameter of the tube. During core drawing and rod drawing, simultaneously the inner diameter and the wall thickness of the drawn tube are defined by a mandrel. Either the mandrel is not fixed but held by the tube itself or in rod drawing the mandrel is held by a rod extending through the inner diameter of the tube. In an embodiment, wherein a mandrel is applied during the drawing process, the drawing die and the mandrel define a ring-shaped gap through which the tube is drawn. When using a mandrel, the outer diameter, the inner diameter as well as the wall thickness may be reduced during the drawing process and the final tube has diameters within tight tolerances. A drawing equipment can either be continuously or discontinuously operated. During the drawing process, the work piece is clamped by a drive on the side of the drawing die, where the finalized tube can be gripped. In order to continuously draw the tube, the drawing equipment in an embodiment needs at least two drawing drives alternately clamping the tube in order to continuously draw the tube through the drawing die.

In an embodiment of the disclosure, the tube after cold forming, such as cold pilger milling or after cold pilger milling and cold drawing is treated by ring autofrettage or ball autofrettage. This method for manufacturing a tube for a distributor fuel rail leads to an enhanced yield strength and reduced crack growth.

In an embodiment of the present disclosure, the tube is after cold forming, such as after cold pilger milling or after cold pilger milling and cold drawing, annealed at a temperature in the range of 400° C. to 460° C., wherein during annealing the tube is kept in a controlled atmosphere. A tube manufactured by this method will obtain high tensile strength and high elongation in high-pressure applications simultaneously.

### BRIEF DESCRIPTION OF THE FIGURES

Further advantages, features and applications of the present disclosure will become apparent from the following description of embodiments and the corresponding figures attached. The foregoing as well as the following detailed description of the embodiments will be better understood when read in conjunction with the appended drawings. It should be understood that the embodiments depicted are not limited to the precise arrangements and instrumentalities shown.

FIG. 1 is a schematic side view of a vehicle having a combustion engine with a fuel distributor rail according to an embodiment of the present disclosure.

FIG. 2 is a flow chart of a method for manufacturing a part of a distributor fuel rail according to an embodiment of the present invention.

### DETAILED DESCRIPTION

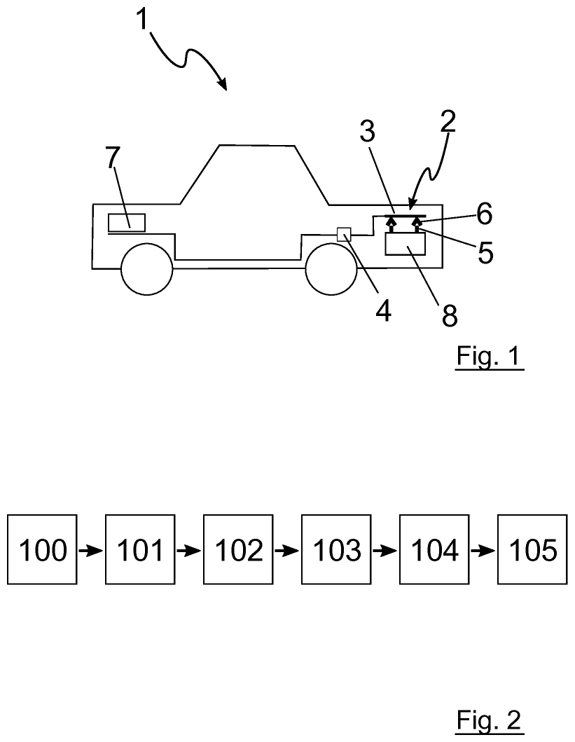

FIG. 1 is a schematic side view of a car 1 having a distributor fuel rail 2 according to an embodiment of the present disclosure attached to a combustion engine 8. In the present embodiment the combustion engine 8 is a diesel engine.

The distributor fuel rail 2 comprises a fuel distributor conduit 3 formed by a seamless steel tube made of an austenitic stainless steel consisting of, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities.

The distributor conduit 3 is located between a fuel pump 4 and injectors 5 accommodated in injector cups 6. The fuel is pumped from a tank 7 by the fuel pump 4 to the injectors 5 under a pressure of 1900 bar.

FIG. 2 is a flow chart describing a method for forming a hollow into the tube 2 used in the application described with reference to FIG. 1. In a first step 100 a melt of an austenitic stainless steel is provided, wherein the austenitic stainless steel consists of, in weight %, C≤0.040, 8.00≤Mn≤10.00, Si≤1.00, P≤0.030, S≤0.030, 19.00≤Cr≤21.50, 5.50≤Ni≤7.50, 0.15 ≤N≤0.40, Mo≤0.75, Cu≤0.75, balance Fe and normally occurring impurities.

After extruding a billet from the melt in a second step 101, the billet is hot rolled into a tubular hollow in step 102. The hollow then gets cooled to room temperature in step 103. In a penultimate step 104 the hollow is cold pilger milled into a tube. In a last step 105, the tube is cold drawn through a drawing dye.

For purposes of the original disclosure, it is noted that all features become apparent for a person skilled in the art from the present description, the figures and the claims even if they have only been described with reference to particular further features and can be combined either on their own or in arbitrary combinations with other features or groups of features disclosed herein as far as such combinations are not explicitly excluded or technical facts exclude such combinations or make them useless. An extensive, explicit description of each possible combination of features has only been omitted in order to provide a short and readable description.

While the disclosure has been shown in detail in the figures and the above description, this description is only an example and is not considered to restrict the scope of protection as it is defined by the claims. The disclosure is not restricted to the disclosed embodiments.

Modifications to the disclosed embodiments are apparent for a person skilled in the art from the drawings, the description and the attached claims. In the claims, the word “comprising” does not exclude other elements or steps and the undefined article “a” does not exclude a plurality. The mere fact that some features have been claimed in different claims does not exclude their combination. Reference numbers in the claims are not considered to restrict the scope of protection.

### REFERENCE NUMERALS

1 car

2 distributor fuel rail

3 fuel distributor conduit

4 fuel pump

5 injectors

6 injector cups

7 tank

8 engine

100 providing a melt of an austenitic stainless steel

101 extruding a billet from the melt

102 hot rolling of the billet into a tubular hollow

103 cooling step

104 cold pilger milling step

105 cold drawing step

1. A distributor fuel rail for a combustion engine with a tubing, wherein at least a section of the tubing is provided by a seamless tube made of an austenitic stainless steel comprising, in weight %,
C≤0.080,
8.00≤Mn≤10.00,
Si≤1.00,
P≤0.030,
S≤0.030,
19.00≤Cr≤21.50,
5.50≤Ni≤7.50,
0.15≤N≤0.40,
Mo≤0.75,
Cu≤0.75,
balance Fe and normally occurring impurities.

2. The distributor fuel rail according to claim 1, wherein the tube is obtained by a method comprising the steps:
providing a melt of an austenitic stainless steel comprising, in weight %,
C≤0.080,
8.00≤Mn≤10.00,
Si≤1.00,
P≤0.030,
S≤0.030,
19.00≤Cr≤21.50,
5.50≤Ni≤7.50,
0.15≤N≤0.40,
Mo≤0.75,
Cu≤0.75,
balance Fe and normally occurring impurities;
extruding a billet from the melt;
hot forming of the billet into a tubular hollow;
cooling the hollow; and
cold forming the hollow into the tube.

3. The distributor fuel rail according to claim 1, wherein the tubing of the distributor fuel rail comprises a distributor conduit, a plurality of injector cups in fluid communication with the distributor conduit and a at least one feeder line in fluid communication with the distributor conduit.

4. The distributor fuel rail according to claim 2, wherein the cold forming is cold pilger milling or cold drawing.

5. The distributor fuel rail according to claim 2, wherein the tube is cold formed by cold pilger milling and the tube after cold pilger milling is cold drawn through a drawing die.

6. The distributor fuel rail according to claim 5, wherein the tube after cold forming is treated by ring autofrettage or ball autofrettage.

7. The distributor fuel rail according to claim 5, wherein the tube after cold pilger milling is annealed at a temperature in a range from 400° C. to 460° C., and wherein during annealing the tube is kept in a controlled atmosphere.

8. The distributor fuel rail according to claim 1, wherein the tube has a wall thickness which is equal to or larger than one quarter of the outer diameter of the tube.

9. A diesel combustion engine comprising the distributor fuel rail according to claim 1.

10. An Otto combustion engine comprising the distributor fuel rail according to claim 1.

11. A vehicle comprising a combustion engine according to claim 10.

12. Use of the distributor fuel rail according to claim 1 for guiding fuel pressurised at 800 bar or more.

13. A method for manufacturing a distributor fuel rail, wherein manufacturing of a tube forming at least part of the distributor fuel rail comprises the steps:
providing a melt of an austenitic stainless steel comprising, in weight %, C≤0.080, 8.00≤Mn≤10.00, Si≤1.00, P≤0.030, S≤0.030, 19.00≤Cr≤21.50, 5.50≤Ni≤7.50, 0.15≤N≤0.40, Mo≤0.75, Cu≤0.75, balance Fe and normally occurring impurities;
extruding a billet from the melt;
hot forming the billet into a tubular hollow;
cooling the hollow; and
cold forming the hollow into the tube.

14. The method according to claim 13, wherein the hollow is cold formed by cold pilger milling and wherein the tube after cold pilger milling is cold drawn through a drawing die.

15. The method according to claim 14, wherein the tube after cold forming is treated by ring autofrettage or ball autofrettage.

16. The distributor fuel rail according to claim 4, wherein the tube after cold forming is treated by ring autofrettage or ball autofrettage.

17. The distributor fuel rail according to claim 4, wherein the tube after cold pilger milling is annealed at a temperature in a range from 400° C. to 460° C., and wherein during annealing the tube is kept in a controlled atmosphere.

18. A vehicle comprising a combustion engine according to claim 9.

19. The method according to claim 13, wherein the tube after cold forming is treated by ring autofrettage or ball autofrettage.
